(19) United States
(12) Patent Application Publication
(10) Pub. No.: US 2021/0391706 A1
(43) Pub. Date: Dec. 16, 2021

(54) BATTERY INTERRUPTER

(71) Applicant: Gerald Laughter, Elko, NV (US)

(72) Inventor: Gerald Laughter, Elko, NV (US)

(21) Appl. No.: 17/352,863

(22) Filed: Jun. 21, 2021

Related U.S. Application Data
(63) Continuation-in-part of application No. 17/187,594, filed on Feb. 26, 2021.
Application No. 17/187,594 is a continuation of application No. 17/027,190, filed on Sep. 21, 2020, now abandoned.
Application No. 17/027,190 is a continuation of application No. 16/518,766, filed on Jul. 22, 2019, now abandoned.
Application No. 16/518,766 is a continuation of application No. 15/880,367, filed on Jan. 25, 2018, now Pat. No. 10,361,553.

(51) Int. Cl. H02H 7/08; H02H 5/00

(52) U.S. Cl. CPC H02H 7/0833; H02H 5/00

(57) ABSTRACT

A battery interrupter system including an electrical motor for a machine, at least one battery which powers an electrical system of a machine, a programable logic controller electrically connected to the electrical system and an ignition electrically connected to the programmable logic controller. The battery interrupter system also includes a button, which initiates the battery interrupter system, is connected to the programmable logic controller, at least one contactor electrically connected to the at least one battery and the programmable logic controller, wherein the programmable logic controller is configured to sends a signal to the at least one contactor to latch-in the contactor and enable an electrical connection between the at least one battery and the electrical system of the machine, and a detection sensor electrically connected to the programmable logic controller, wherein the detection sensor identifies operating conditions of the electrical system.

### CROSS-REFERENCE TO RELATED APPLICATIONS

This application is a continuation-in-part of U.S. patent application Ser. No. 17/187,594, filed Feb. 26, 2021, which is a continuation of U.S. patent application Ser. No. 17/027,190, filed Sep. 21, 20201, which is a continuation of U.S. patent application Ser. No. 16/518,766, filed Jul. 22, 2019, which is a continuation of U.S. patent application Ser. No. 15/880,367, filed on Jan. 25, 2018 (now U.S. Pat. No. 10,361,553, issued on Jul. 23, 2019), all of which is hereby incorporated by reference herein in its entirety, including but not limited to those portions that specifically appear hereinafter, the incorporation by reference being made with the following exception: in the event that any portion of the above-referenced application is inconsistent with this application, this application superseded said above-referenced application.

### STATEMENT REGARDING FEDERALLY SPONSORED RESEARCH OR DEVELOPMENT

Not Applicable.

### BACKGROUND

### 1. The Field of the Present Disclosure

The present disclosure relates generally to battery interrupter systems that can be used to insulate batteries or power sources from heavy machinery or vehicle in times of inactivity or in the presence of a hazard, such as fire or excessive heat.

### 2. Description of Related Art

The need to protect engines, motors and electrical systems from damaging or destructive operating conditions is essential for the proper operation of machinery or vehicles. Continued operation of an operating system under hazard conditions, such as fire, can lead to a catastrophic failure of the machine. Monitoring and protection systems are used on machines to discourage operation of the machine when the operating conditions exceed and/or are below acceptable limits. In the past, various systems of varying degrees of sophistication have been developed to monitor conditions in a machine, and/or other parameters, in order to implement an machine protection protocol.

In some monitoring systems, an analog gauge signals the advent of an unacceptable condition. Analog or digital gauges provide continuous readings of, for example, fluid levels and temperatures, but require constant monitoring by an operator.

Aftermarket retrofit systems have been available that electronically monitor certain operating parameters. Typically, these systems work in conjunction with original factory installed engine systems. As such, the aftermarket systems are affected by or affect the existing factory systems, which can result in voiding the warranty on such OEM systems. Additionally, many of the retrofit systems can and are circumvented by component failures, wire disconnects, and/or operator manipulation.

Current operating system protection and monitoring systems do not provide a mechanism for automatically implementing a protocol when parameters are within a predetermined fault condition.

The invention as herein disclosed and described is directed to a system and protocol for monitoring parameters or conditions and controlling the operating system and accessory functions.

The prior art is thus characterized by several disadvantages that are addressed by the present disclosure. The present disclosure minimizes, and in some aspects eliminates, the above-mentioned failures, and other problems, by utilizing the methods and structural features described herein.

The features and advantages of the present disclosure will be set forth in the description which follows, and in part will be apparent from the description, or may be learned by the practice of the present disclosure without undue experimentation. The features and advantages of the present disclosure may be realized and obtained by means of the instruments and combinations particularly pointed out in the appended claims. Any discussion of documents, acts, materials, devices, articles or the like which has been included in the present specification is not to be taken as an admission that any or all of these matters form part of the prior art base, or were common general knowledge in the field relevant to the present disclosure as it existed before the priority date of each claim of this application.

### BRIEF DESCRIPTION OF THE DRAWINGS

The features and advantages of the disclosure will become apparent from a consideration of the subsequent detailed description presented in connection with the accompanying drawings in which:

FIG. 1 is a schematic diagram of the battery interrupter system of the disclosed invention;

FIG. 2 is a circuit diagram of the embodiment of FIG. 1;

FIG. 3 is a circuit diagram of another embodiment of the invention;

FIG. 4 is a circuit diagram of another embodiment of the invention;

FIG. 5 is a circuit diagram of another embodiment of the invention;

FIG. 6 is a circuit diagram of another embodiment of the invention;

FIG. 7 is a circuit diagram of another embodiment of the invention;

FIG. 8 is a circuit diagram of another embodiment of the invention;

FIG. 9 is a schematic diagram of the battery interrupter system of the disclosed invention;

FIG. 10 is a circuit diagram of the embodiment of FIG. 1;

FIG. 11 is a circuit diagram of another embodiment of the invention;

FIG. 12 is a circuit diagram of another embodiment of the invention;

FIG. 13 is a circuit diagram of another embodiment of the invention;

FIG. 14 is a circuit diagram of another embodiment of the invention; and

FIG. 15 is a circuit diagram of another embodiment of the invention.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present structural embodiments and methods for using and constructing a battery interrupter system are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

Applicant has invented an improved battery interrupter system for heavy machinery or vehicles. This battery interrupter system enable a battery power source to be interrupted and then isolated from the rest of an electronic operating system to prevent or mitigate fire damage and save and conserve battery life when the corresponding heavy machinery or vehicle is not in use. Conventionally, if a fire begins or extends into an engine compartment or electrical housing, the power source (typically a battery) still provides electrical current which exacerbates the fire, requiring faster and often more extreme extinguishing actions. The following detailed description of Applicant's battery interrupter will identify how these conventional heavy machinery fire problems are overcome by the disclosed battery interrupter system.

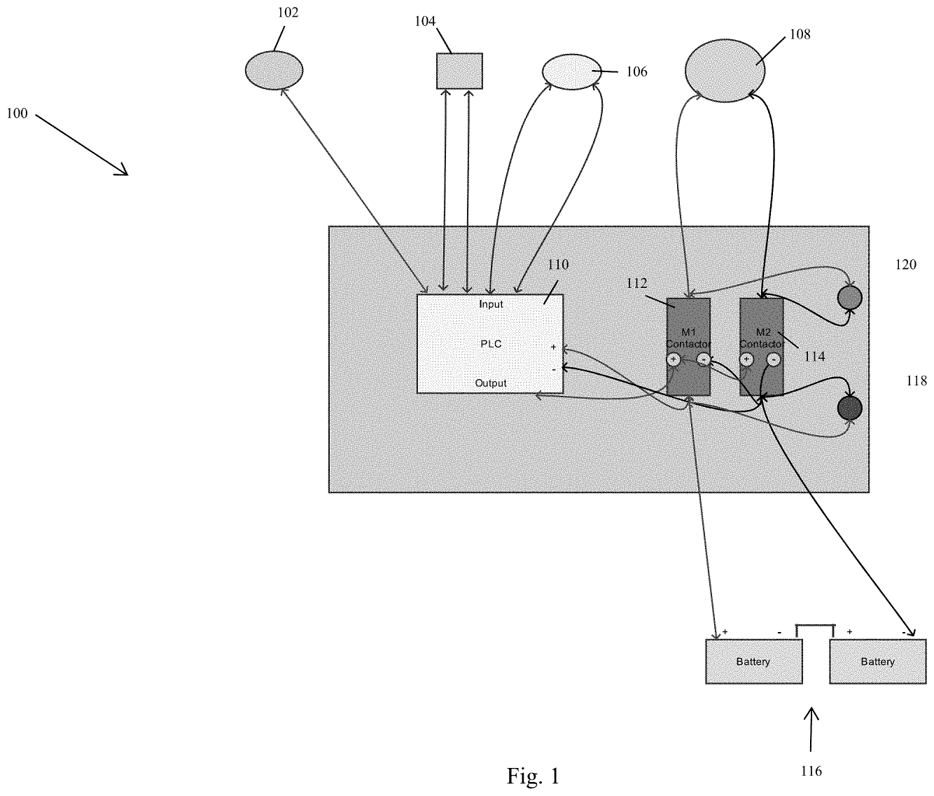

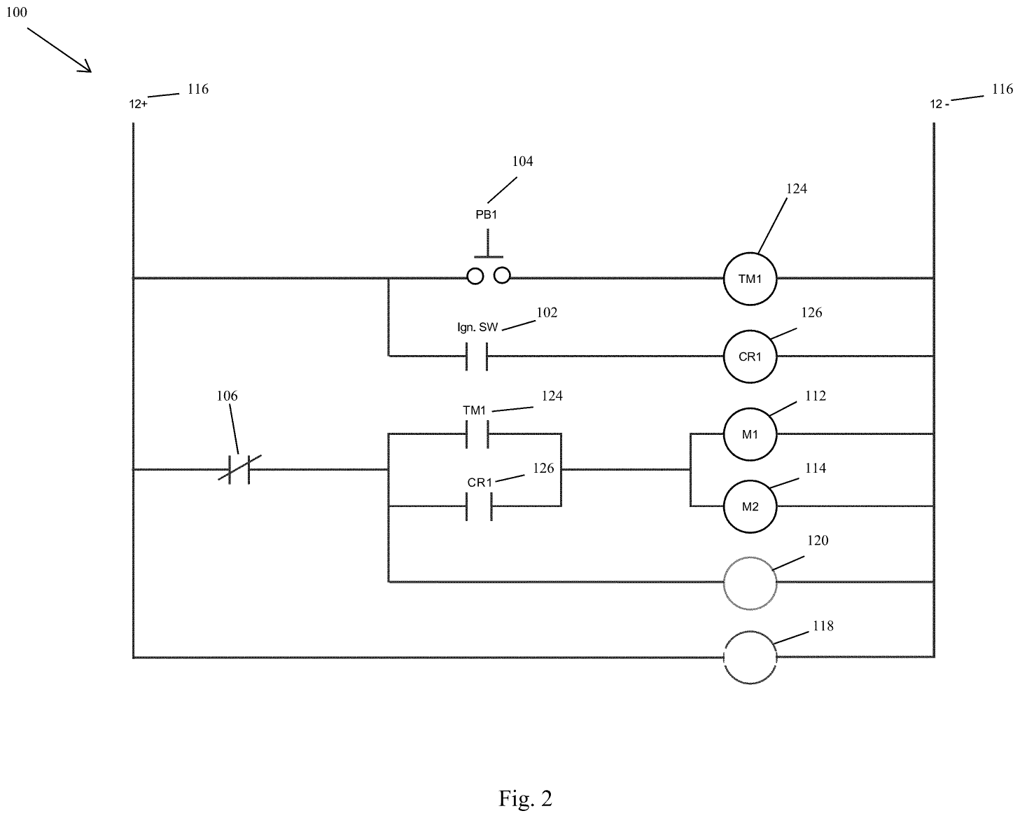

FIGS. 1 and 2, illustrate a schematic diagram and circuit diagram, respectively, identifying the components and corresponding connections of a battery interrupter system 100. The battery interrupter system 100 can be manufactured at the same time as electrical components of a machine or can be retrofit into an existing machine or vehicle. The battery interrupter system 100 can therefore include and cooperate with conventional machine or vehicle operating systems, including operating a motor or engine of the machine.

The battery interrupter system 100 includes an ignition switch 102 and a push button 104, or “on” button, which initiates the system 100. When an operator presses the push button 104 to initiate the system 100, the push button 104 sends an input signal to a programmable logic controller 110, or PLC, to begin starting or initiating the system 100.

When the operator first begins initiating the system 100, from a cold start, contactors 112 and 114 are in an open position, essentially isolating the battery 116, or batteries, from the rest of the system 100. By isolating the battery 116 in this way, the system 100 is not receiving any power, or open to receive power, from the battery 116, thereby conserving the battery power and limiting susceptibility to fire within the system 100. The battery may be 12 volts, as shown in FIGS. 1 and 2, or may be 24 volts or another desired voltage.

When the PLC 110 receives the input signal from the push button 104, the PLC 110 is programed to send power to the contactors 112 and 114 causing them to latch in. The contactors 112 and 114 are also electrically connected to an electrical system 108, often including a motor, of the heavy machinery or vehicle, providing power thereto via the battery 116. Additionally, when the PLC 110 receives the input signal from the push button 104, the PLC 110 is programmed to start a timer 124 which begins a predetermined countdown. The countdown can be preset, or changed, if desired. For example, the countdown can be set at 5 minutes, or less, or more. If after the countdown ends and the PLC 110 does not receive an input from an ignition switch 102, then the PLC 110 will time out and send power to the contactors 112 and 114 to unlatch them and again isolate the battery 116. When the contactors are latched in an active state indicator light 120 may illuminate. The indicator light 120 may be visible to the operator to ensure that the system 100 is active and functioning properly.

As also illustrated in the circuit diagram in FIG. 2, when the contactors 112 and 114 are latched in and an input signal from the ignition switch 102 is received by the PLC 110, the battery 116 will maintain connection with the contactors 112 and 114 and provide power to the system 100 in an active state. When the system 100 is in the active state, the system 100 is monitored by at least one sensor 106, in at least one of three ways. The sensor 106 can monitor pressure, as with an Ansul system, or monitor heat, such as spot detecting with spot detector, or monitor flames, as with a fire eye sensor. The senor 106 in FIG. 2 is a pressure monitoring sensor, such as an Ansul system. If at any time the sensor 106 detects a hazard or problem, the sensor 106 sends a signal to the PLC 110. Additionally, is at any time the system 100 is not active or has detected a hazard, a second indicator light 118, such as a red light, may be illuminated indicating to the operator that the system is no longer active or receiving power from the battery 116.

Upon receiving a hazard signal from the sensor 106 the PLC 110 sends power, a voltage, to unlatch the contactors 112 and 114 to again isolate the battery and mitigate any damage done by the hazard. If no hazard is detected then the sensor will maintain the completed circuit through the timer 124 and start relay 128.

In situations where the heavy machinery or vehicle has been used without problem or hazard detection, at the end of operation when the operator is finished using the equipment, the ignition switch 102 is turned off, and the timer 124 will once again start its countdown. Once the countdown is completed without the ignition switch 102 being restarted, the PLC 110 will send power to unlatch the contactors 112 and 114 and isolate the battery 116, facilitating a longer battery life since the battery will be isolated from the machine while the machine is not in use.

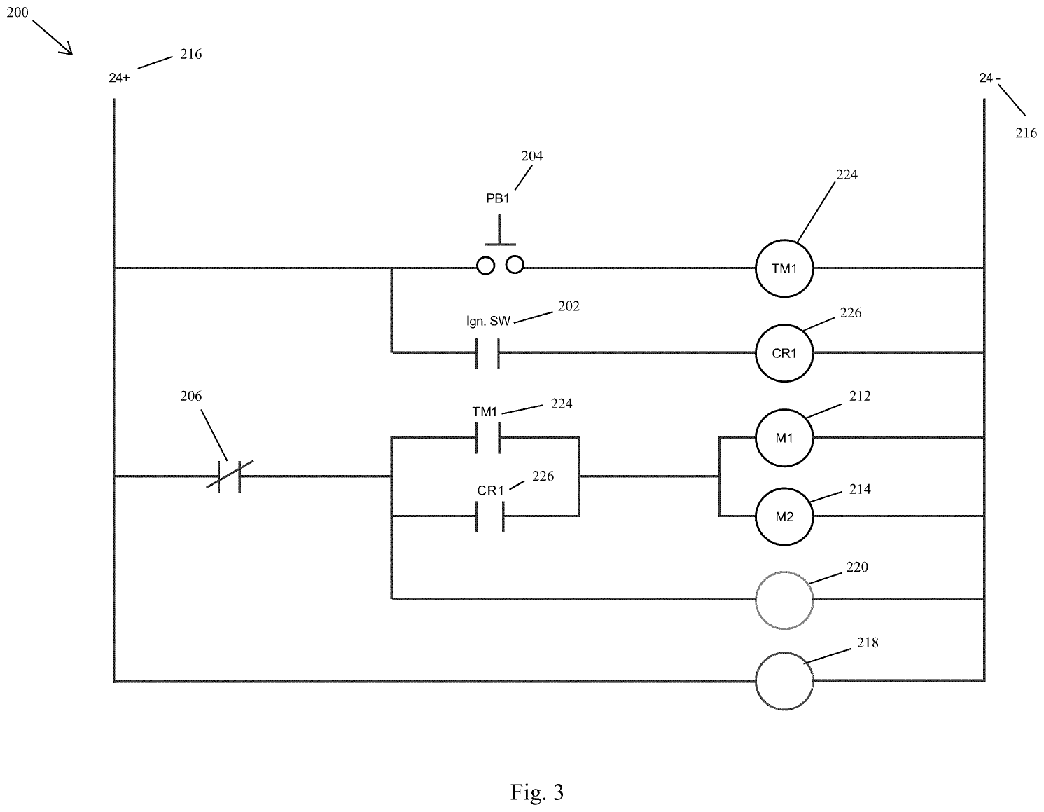

In another embodiment of the disclosed invention, as shown in FIG. 3, a battery interrupter system 200 includes an ignition switch 202 and a push button 204, or “on” button, which initiates the system 200. When an operator presses the push button 204 to initiate the system 200, the push button 204 sends an input signal to a programmable logic controller 210, or PLC, to begin starting or initiating the system 200.

When the operator first begins initiating the system 200, from a cold start, contactors 212 and 214 are in an open position, essentially isolating the battery 216, or batteries, from the rest of the system 200. By isolating the battery 216 in this way, the system 200 is not receiving any power, or open to receive power, from the battery 216, thereby conserving the battery power and limiting susceptibility to fire within the system 100. The battery 216 may be 24 volts, as shown in FIG. 3, or may be 12 volts or another desired voltage.

When the PLC 210 receives the input signal from the push button 204, the PLC 210 is programed to send power to the contactors 112 and 114 causing them to latch in. Additionally, when the PLC 210 receives the input signal from the push button 204, the PLC 210 is programmed to start a timer 224 which begins a predetermined countdown. The countdown can be preset, or changed, if desired. For example, the countdown can be set at 5 minutes, or less, or more. If after the countdown ends and the PLC 210 does not receive an input from an ignition switch 202, then the PLC 210 will time out and send power to the contactors 212 and 214 to unlatch them and again isolate the battery 216. When the contactors are latched in an active state indicator light 220 may illuminate. The indicator light 220 may be visible to the operator to ensure that the system 200 is active and functioning properly.

As also illustrated in the circuit diagram in FIG. 3, when the contactors 212 and 214 are latched in and an input signal from the ignition switch 202 is received by the PLC 210, the battery 216 will maintain connection with the contactors 212 and 214 and provide power to the system 200 in an active state. When the system 200 is in the active state, the system 200 is monitored by at least one sensor 206, in at least one of three ways. The sensor 206 can monitor pressure, as with an Ansul system, or monitor heat, such as spot detecting with spot detector, or monitor flames, as with a fire eye sensor. The senor 206 in FIG. 3 is a pressure monitoring sensor, such as an Ansul system. If at any time the sensor 206 detects a hazard or problem, the sensor 206 sends a signal to the PLC 210. Additionally, is at any time the system 200 is not active or has detected a hazard, a second indicator light 218, such as a red light, may be illuminated indicating to the operator that the system is no longer active or receiving power from the battery 216.

Upon receiving a hazard signal from the sensor 206 the PLC 210 sends power, a voltage, to unlatch the contactors 212 and 214 to again isolate the battery and mitigate any damage done by the hazard. If no hazard is detected then the sensor will maintain the completed circuit through the timer 224 and start relay 228.

In situations where the heavy machinery or vehicle has been used without problem or hazard detection, at the end of operation when the operator is finished using the equipment, the ignition switch 202 is turned off, and the timer 224 will once again start its countdown. Once the countdown is completed without the ignition switch 202 being restarted, the PLC 210 will send power to unlatch the contactors 212 and 214 and isolate the battery 216, facilitating a longer battery life since the battery will be isolated from the machine while the machine is not in use.

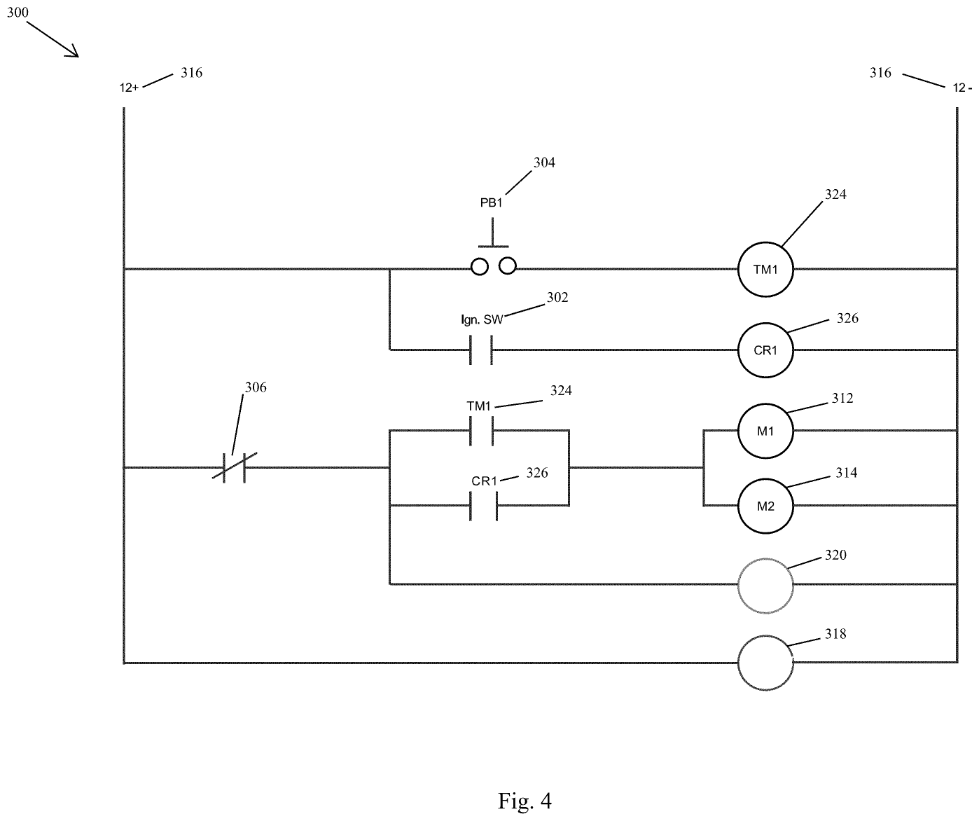

In another embodiment of the disclosed invention, as shown in FIG. 4, a battery interrupter system 300 includes an ignition switch 302 and a push button 304, or “on” button, which initiates the system 300. When an operator presses the push button 304 to initiate the system 300, the push button 304 sends an input signal to a programmable logic controller 310, or PLC, to begin starting or initiating the system 300.

When the operator first begins initiating the system 300, from a cold start, contactors 312 and 314 are in an open position, essentially isolating the battery 316, or batteries, from the rest of the system 300. By isolating the battery 316 in this way, the system 300 is not receiving any power, or open to receive power, from the battery 316, thereby conserving the battery power and limiting susceptibility to fire within the system 300. The battery 316 may be 12 volts, as shown in FIG. 4, or may be 24 volts or another desired voltage.

When the PLC 310 receives the input signal from the push button 304, the PLC 310 is programed to send power to the contactors 312 and 314 causing them to latch in. Additionally, when the PLC 310 receives the input signal from the push button 304, the PLC 310 is programmed to start a timer 324 which begins a predetermined countdown. The countdown can be preset, or changed, if desired. For example, the countdown can be set at 5 minutes, or less, or more. If after the countdown ends and the PLC 310 does not receive an input from an ignition switch 302, then the PLC 310 will time out and send power to the contactors 312 and 314 to unlatch them and again isolate the battery 316. When the contactors are latched in an active state indicator light 320 may illuminate. The indicator light 320 may be visible to the operator to ensure that the system 300 is active and functioning properly.

As also illustrated in the circuit diagram in FIG. 4, when the contactors 312 and 314 are latched in and an input signal from the ignition switch 302 is received by the PLC 310, the battery 316 will maintain connection with the contactors 312 and 314 and provide power to the system 300 in an active state. When the system 300 is in the active state, the system 300 is monitored by at least one sensor 306, in at least one of three ways. The sensor 306 can monitor pressure, as with an Ansul system, or monitor heat, with a spot detector, or monitor flames, as with a fire eye sensor. The senor 306 in FIG. 4 is a heat monitoring sensor, such as an spot detector. If at any time the sensor 306 detects a hazard or problem, the sensor 306 sends a signal to the PLC 310. Additionally, is at any time the system 300 is not active or has detected a hazard, a second indicator light 318, such as a red light, may be illuminated indicating to the operator that the system is no longer active or receiving power from the battery 316.

Upon receiving a hazard signal from the sensor 306 the PLC 310 sends power, a voltage, to unlatch the contactors 312 and 314 to again isolate the battery and mitigate any damage done by the hazard. If no hazard is detected then the sensor will maintain the completed circuit through the timer 324 and start relay 328.

In situations where the heavy machinery or vehicle has been used without problem or hazard detection, at the end of operation when the operator is finished using the equipment, the ignition switch 302 is turned off, and the timer 324 will once again start its countdown. Once the countdown is completed without the ignition switch 302 being restarted, the PLC 310 will send power to unlatch the contactors 312 and 314 and isolate the battery 316, facilitating a longer battery life since the battery will be isolated from the machine while the machine is not in use.

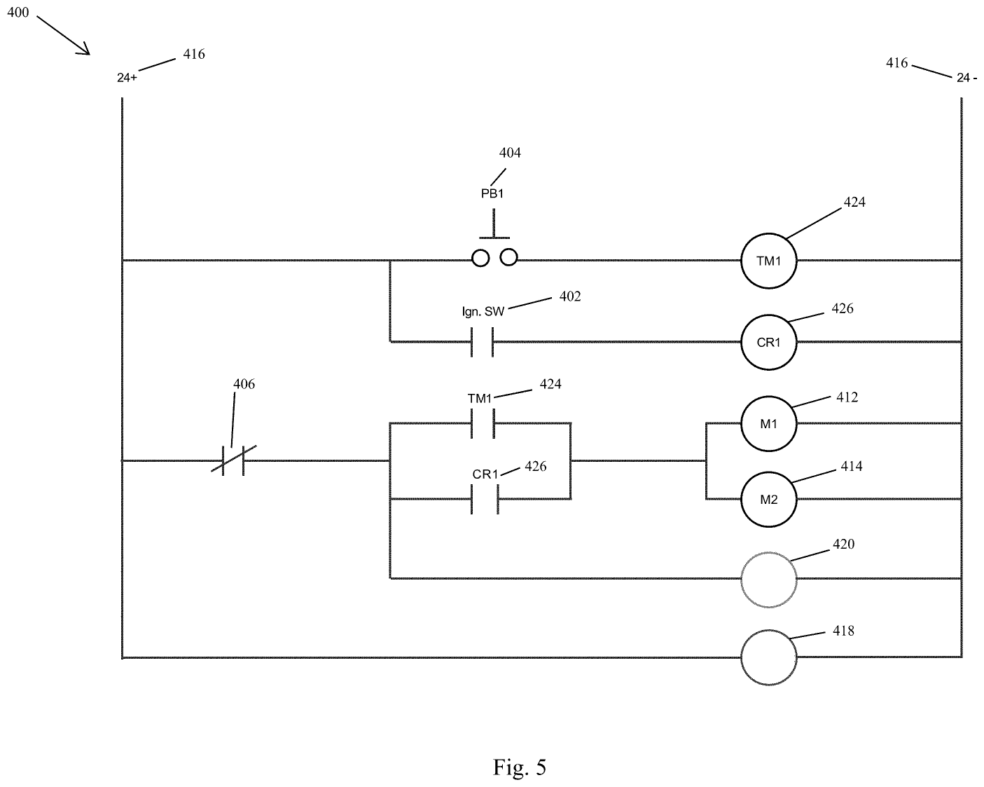

In another embodiment of the disclosed invention, as shown in FIG. 5, a battery interrupter system 400 includes an ignition switch 402 and a push button 404, or “on” button, which initiates the system 400. When an operator presses the push button 404 to initiate the system 400, the push button 404 sends an input signal to a programmable logic controller 410, or PLC, to begin starting or initiating the system 400.

When the operator first begins initiating the system 400, from a cold start, contactors 412 and 414 are in an open position, essentially isolating the battery 416, or batteries, from the rest of the system 400. By isolating the battery 416 in this way, the system 400 is not receiving any power, or open to receive power, from the battery 416, thereby conserving the battery power and limiting susceptibility to fire within the system 400. The battery 416 may be 24 volts, as shown in FIG. 5, or may be 14 volts or another desired voltage.

When the PLC 410 receives the input signal from the push button 404, the PLC 410 is programed to send power to the contactors 412 and 414 causing them to latch in. Additionally, when the PLC 410 receives the input signal from the push button 404, the PLC 410 is programmed to start a timer 424 which begins a predetermined countdown. The countdown can be preset, or changed, if desired. For example, the countdown can be set at 5 minutes, or less, or more. If after the countdown ends and the PLC 410 does not receive an input from an ignition switch 402, then the PLC 410 will time out and send power to the contactors 412 and 414 to unlatch them and again isolate the battery 416. When the contactors are latched in an active state indicator light 420 may illuminate. The indicator light 420 may be visible to the operator to ensure that the system 400 is active and functioning properly.

As also illustrated in the circuit diagram in FIG.5, when the contactors 412 and 414 are latched in and an input signal from the ignition switch 402 is received by the PLC 410, the battery 416 will maintain connection with the contactors 412 and 414 and provide power to the system 400 in an active state. When the system 400 is in the active state, the system 400 is monitored by at least one sensor 406, in at least one of three ways. The sensor 406 can monitor pressure, as with an Ansul system, or monitor heat, with a spot detector, or monitor flames, as with a fire eye sensor. The senor 406 in FIG. 5 is a heat monitoring sensor, such as an spot detector. If at any time the sensor 406 detects a hazard or problem, the sensor 406 sends a signal to the PLC 410. Additionally, is at any time the system 400 is not active or has detected a hazard, a second indicator light 418, such as a red light, may be illuminated indicating to the operator that the system is no longer active or receiving power from the battery 416.

Upon receiving a hazard signal from the sensor 406 the PLC 410 sends power, a voltage, to unlatch the contactors 412 and 414 to again isolate the battery and mitigate any damage done by the hazard. If no hazard is detected then the sensor will maintain the completed circuit through the timer 424 and start relay 428.

In situations where the heavy machinery or vehicle has been used without problem or hazard detection, at the end of operation when the operator is finished using the equipment, the ignition switch 402 is turned off, and the timer 424 will once again start its countdown. Once the countdown is completed without the ignition switch 402 being restarted, the PLC 410 will send power to unlatch the contactors 412 and 414 and isolate the battery 416, facilitating a longer battery life since the battery will be isolated from the machine while the machine is not in use.

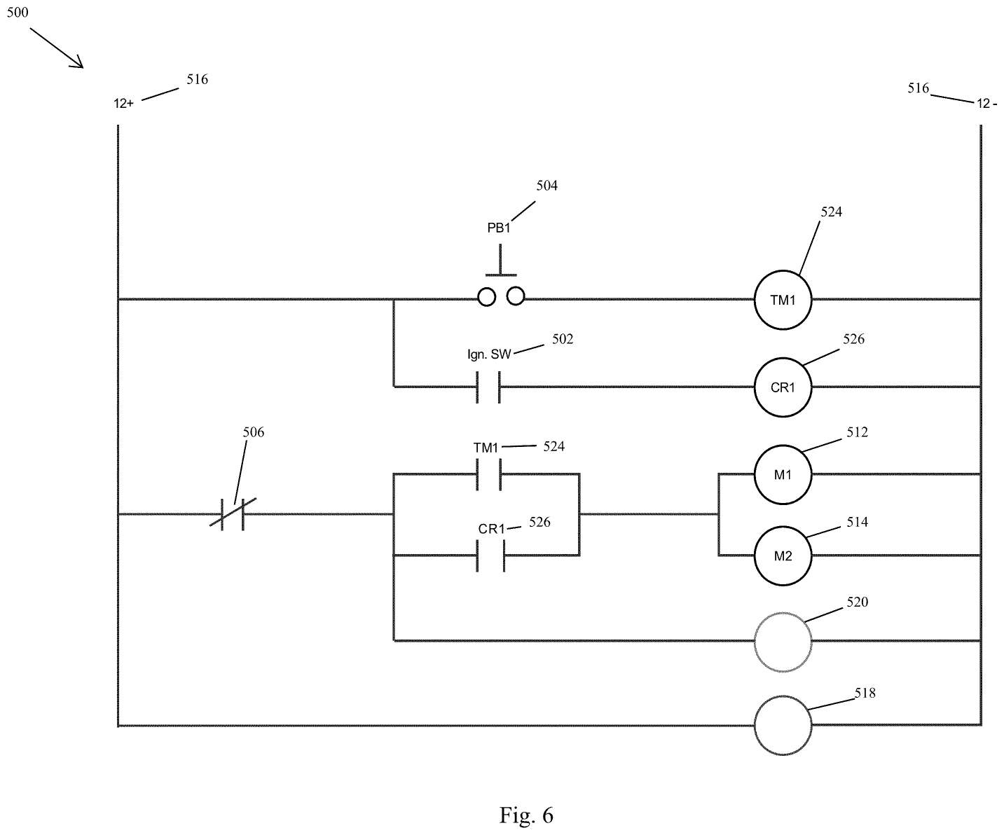

In another embodiment of the disclosed invention, as shown in FIG. 6, a battery interrupter system 500 includes an ignition switch 502 and a push button 504, or “on” button, which initiates the system 500. When an operator presses the push button 504 to initiate the system 500, the push button 504 sends an input signal to a programmable logic controller 510, or PLC, to begin starting or initiating the system 500.

When the operator first begins initiating the system 500, from a cold start, contactors 512 and 514 are in an open position, essentially isolating the battery 516, or batteries, from the rest of the system 500. By isolating the battery 516 in this way, the system 500 is not receiving any power, or open to receive power, from the battery 516, thereby conserving the battery power and limiting susceptibility to fire within the system 500. The battery 516 may be 12 volts, as shown in FIG. 6, or may be 24 volts or another desired voltage.

When the PLC 510 receives the input signal from the push button 504, the PLC 510 is programed to send power to the contactors 512 and 514 causing them to latch in. Additionally, when the PLC 510 receives the input signal from the push button 504, the PLC 510 is programmed to start a timer 524 which begins a predetermined countdown. The countdown can be preset, or changed, if desired. For example, the countdown can be set at 5 minutes, or less, or more. If after the countdown ends and the PLC 510 does not receive an input from an ignition switch 502, then the PLC 510 will time out and send power to the contactors 512 and 514 to unlatch them and again isolate the battery 516. When the contactors are latched in an active state indicator light 520 may illuminate. The indicator light 520 may be visible to the operator to ensure that the system 500 is active and functioning properly.

As also illustrated in the circuit diagram in FIG.6, when the contactors 512 and 514 are latched in and an input signal from the ignition switch 502 is received by the PLC 510, the battery 516 will maintain connection with the contactors 512 and 514 and provide power to the system 500 in an active state. When the system 500 is in the active state, the system 500 is monitored by at least one sensor 506, in at least one of three ways. The sensor 506 can monitor pressure, as with an Ansul system, or monitor heat, with a spot detector, or monitor flames, as with a fire eye sensor. The senor 506 in FIG. 6 is a flame monitoring sensor, such as a fire eye sensor. If at any time the sensor 506 detects a hazard or problem, the sensor 506 sends a signal to the PLC 510. Additionally, is at any time the system 500 is not active or has detected a hazard, a second indicator light 518, such as a red light, may be illuminated indicating to the operator that the system is no longer active or receiving power from the battery 516.

Upon receiving a hazard signal from the sensor 506 the PLC 510 sends power, a voltage, to unlatch the contactors 512 and 514 to again isolate the battery and mitigate any damage done by the hazard. If no hazard is detected then the sensor will maintain the completed circuit through the timer 524 and start relay 528.

In situations where the heavy machinery or vehicle has been used without problem or hazard detection, at the end of operation when the operator is finished using the equipment, the ignition switch 502 is turned off, and the timer 524 will once again start its countdown. Once the countdown is completed without the ignition switch 502 being restarted, the PLC 510 will send power to unlatch the contactors 512 and 514 and isolate the battery 516, facilitating a longer battery life since the battery will be isolated from the machine while the machine is not in use.

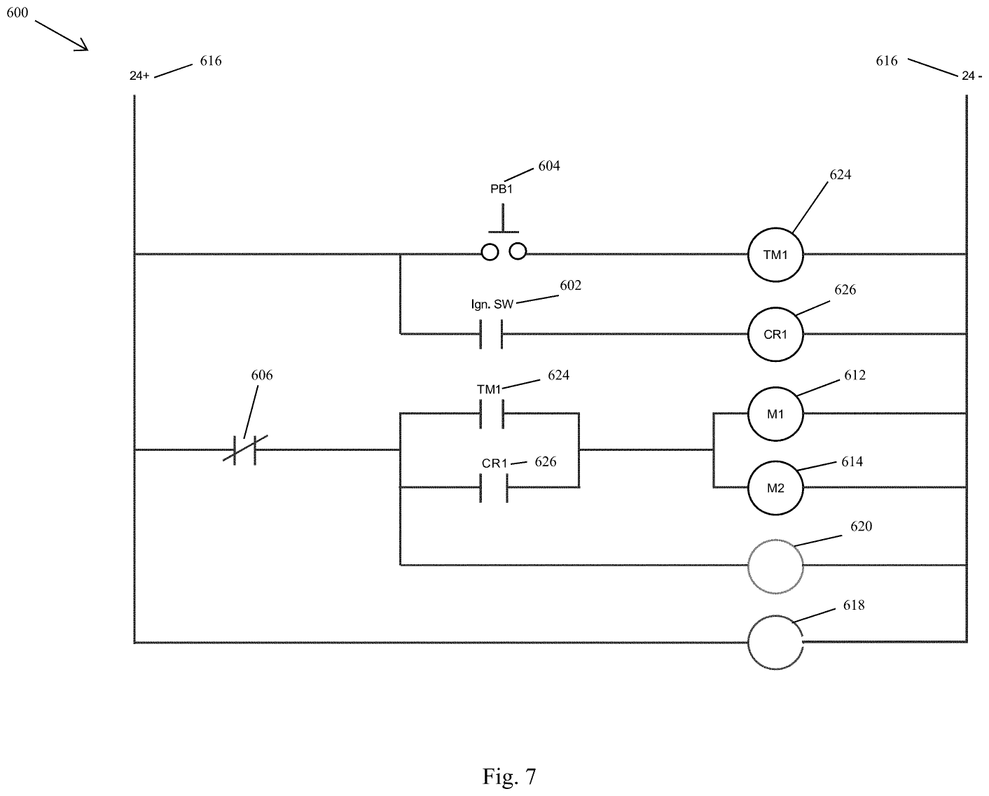

In another embodiment of the disclosed invention, as shown in FIG. 7, a battery interrupter system 600 includes an ignition switch 602 and a push button 604, or “on” button, which initiates the system 600. When an operator presses the push button 604 to initiate the system 600, the push button 604 sends an input signal to a programmable logic controller 610, or PLC, to begin starting or initiating the system 600.

When the operator first begins initiating the system 600, from a cold start, contactors 612 and 614 are in an open position, essentially isolating the battery 616, or batteries, from the rest of the system 600. By isolating the battery 616 in this way, the system 600 is not receiving any power, or open to receive power, from the battery 616, thereby conserving the battery power and limiting susceptibility to fire within the system 600. The battery 616 may be 24 volts, as shown in FIG. 7, or may be 12 volts or another desired voltage.

When the PLC 610 receives the input signal from the push button 604, the PLC 610 is programed to send power to the contactors 612 and 614 causing them to latch in. Additionally, when the PLC 610 receives the input signal from the push button 604, the PLC 610 is programmed to start a timer 624 which begins a predetermined countdown. The countdown can be preset, or changed, if desired. For example, the countdown can be set at 6 minutes, or less, or more. If after the countdown ends and the PLC 610 does not receive an input from an ignition switch 602, then the PLC 610 will time out and send power to the contactors 612 and 614 to unlatch them and again isolate the battery 616. When the contactors are latched in an active state indicator light 620 may illuminate. The indicator light 620 may be visible to the operator to ensure that the system 600 is active and functioning properly.

As also illustrated in the circuit diagram in FIG.7, when the contactors 612 and 614 are latched in and an input signal from the ignition switch 602 is received by the PLC 610, the battery 616 will maintain connection with the contactors 612 and 614 and provide power to the system 600 in an active state. When the system 600 is in the active state, the system 600 is monitored by at least one sensor 606, in at least one of three ways. The sensor 606 can monitor pressure, as with an Ansul system, or monitor heat, with a spot detector, or monitor flames, as with a fire eye sensor. The senor 606 in FIG. 7 is a flame monitoring sensor, such as a fire eye sensor. If at any time the sensor 606 detects a hazard or problem, the sensor 606 sends a signal to the PLC 610. Additionally, is at any time the system 600 is not active or has detected a hazard, a second indicator light 618, such as a red light, may be illuminated indicating to the operator that the system is no longer active or receiving power from the battery 616.

Upon receiving a hazard signal from the sensor 606 the PLC 610 sends power, a voltage, to unlatch the contactors 612 and 614 to again isolate the battery and mitigate any damage done by the hazard. If no hazard is detected then the sensor will maintain the completed circuit through the timer 624 and start relay 628.

In situations where the heavy machinery or vehicle has been used without problem or hazard detection, at the end of operation when the operator is finished using the equipment, the ignition switch 602 is turned off, and the timer 624 will once again start its countdown. Once the countdown is completed without the ignition switch 602 being restarted, the PLC 610 will send power to unlatch the contactors 612 and 614 and isolate the battery 616, facilitating a longer battery life since the battery will be isolated from the machine while the machine is not in use.

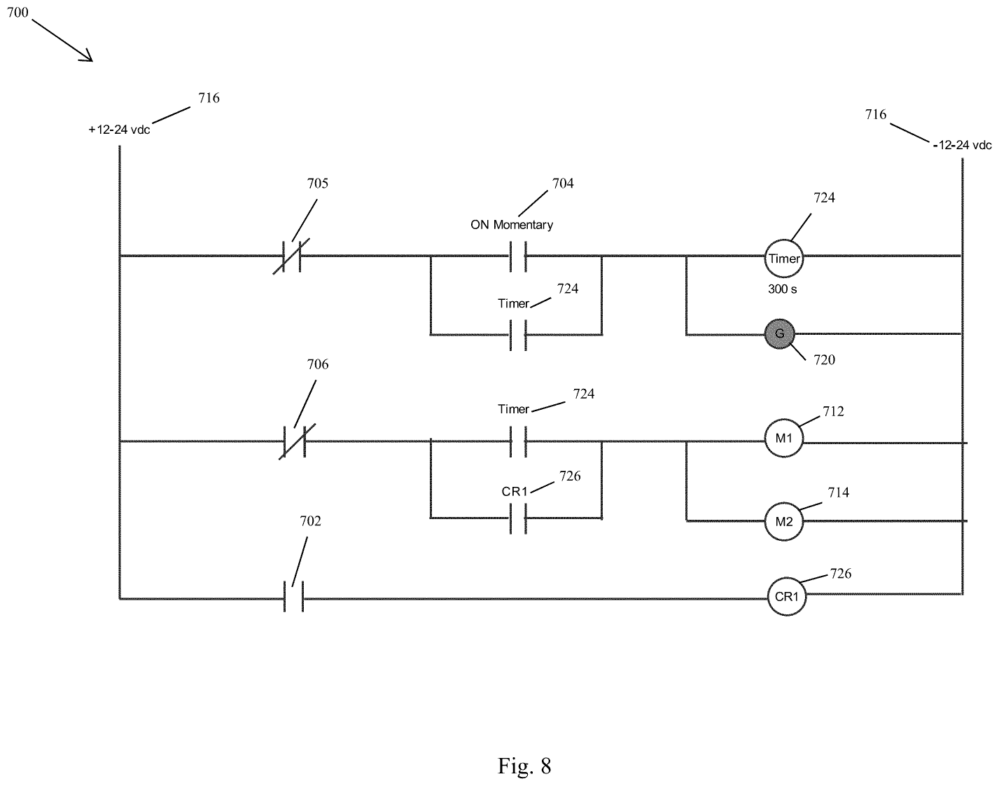

In another embodiment of the disclosed invention, as shown in FIG. 8, a battery interrupter system 700 includes an ignition switch 702 and a push button 704, or “on” button, which initiates the system 700. When an operator presses the push button 704 to initiate the system 700, the push button 704 sends an input signal to a programmable logic controller 710, or PLC, to begin starting or initiating the system 700.

When the operator first begins initiating the system 700, from a cold start, contactors 712 and 714 are in an open position, essentially isolating the battery 716, or batteries, from the rest of the system 700. By isolating the battery 716 in this way, the system 700 is not receiving any power, or open to receive power, from the battery 716, thereby conserving the battery power and limiting susceptibility to fire within the system 700. The battery 716 may be 12 volts, as shown in FIG. 8, or may be 24 volts or another desired voltage.

When the PLC 710 receives the input signal from the push button 704, the PLC 710 is programed to send power to the contactors 712 and 714 causing them to latch in. Additionally, when the PLC 710 receives the input signal from the push button 704, the PLC 710 is programmed to start a timer 724 which begins a predetermined countdown. The countdown can be preset, or changed, if desired. For example, the countdown can be set at 5 minutes, or less, or more. If after the countdown ends and the PLC 710 does not receive an input from an ignition switch 702, then the PLC 710 will time out and send power to the contactors 712 and 714 to unlatch them and again isolate the battery 716. When the contactors are latched in an active state indicator light 720 may illuminate. The indicator light 720 may be visible to the operator to ensure that the system 700 is active and functioning properly.

As also illustrated in the circuit diagram in FIG.8, when the contactors 712 and 714 are latched in and an input signal from the ignition switch 702 is received by the PLC 710, the battery 716 will maintain connection with the contactors 712 and 714 and provide power to the system 700 in an active state. When the system 700 is in the active state, the system 700 is monitored by at least one sensor 705 or 706, in at least one of three ways. The sensor 706 can monitor pressure, as with an Ansul system, or monitor heat, with a spot detector, or monitor flames, as with a fire eye sensor. The senors 705 and 706 in FIG. 8 are pressure monitoring or heat monitoring sensors, such as a Ansul or spot detector sensors. If at any time the sensor 706 detects a hazard or problem, the sensor 706 sends a signal to the PLC 710.

Upon receiving a hazard signal from the sensor 706 the

PLC 710 sends power, a voltage, to unlatch the contactors 712 and 714 to again isolate the battery and mitigate any damage done by the hazard. If no hazard is detected then the sensor will maintain the completed circuit through the timer 724 and start relay 728.

In situations where the heavy machinery or vehicle has been used without problem or hazard detection, at the end of operation when the operator is finished using the equipment, the ignition switch 702 is turned off, and the timer 724 will once again start its countdown. Once the countdown is completed without the ignition switch 702 being restarted, the PLC 710 will send power to unlatch the contactors 712 and 714 and isolate the battery 716, facilitating a longer battery life since the battery will be isolated from the machine while the machine is not in use.

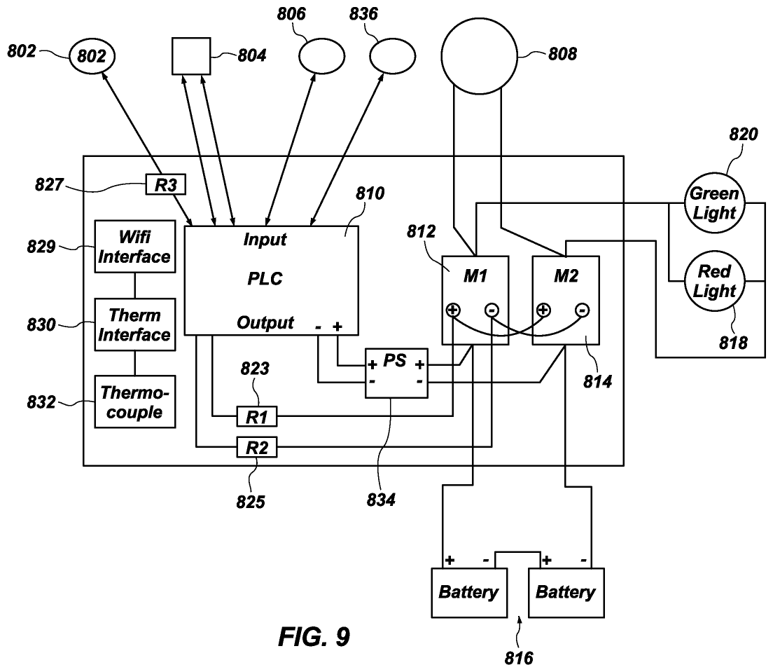

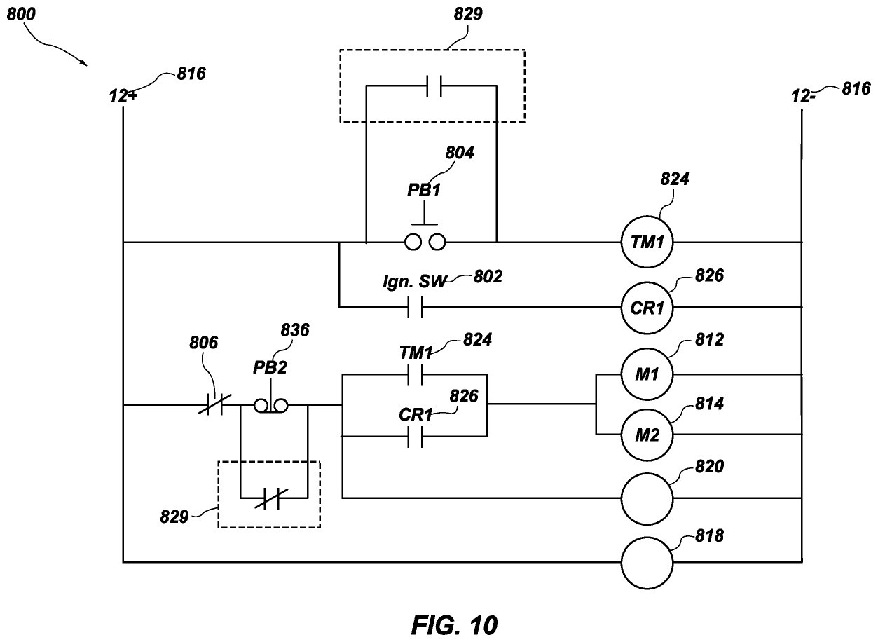

FIGS. 9 and 10, illustrate a schematic diagram and circuit diagram, respectively, identifying the components and corresponding connections of a battery interrupter system 800. The battery interrupter system 800 can be manufactured at the same time as electrical components of a machine or can be retrofit into an existing machine or vehicle. The battery interrupter system 800 can therefore include and cooperate with conventional machine or vehicle operating systems, including operating a motor or engine of the machine.

The battery interrupter system 800 includes an ignition switch 802 and a push button 804, or “on” button, which initiates the system 800. When an operator presses the push button 804 to initiate the system 800, the push button 804 sends an input signal to a programmable logic controller 810, or PLC, to begin starting or initiating the system 800.

When the operator first begins initiating the system 800, from a cold start, contactors 812 and 814 are in an open position, essentially isolating the battery 816, or batteries, from the rest of the system 800. By isolating the battery 216 in this way, the system 800 is not receiving any power, or open to receive power, from the battery 816, thereby conserving the battery power and limiting susceptibility to fire within the system 800. The battery may be 12 volts, as shown in FIGS. 9 and 10, or may be 24 volts or another desired voltage.

When the PLC 810 receives the input signal from the push button 804, the PLC 810 is programed to send power to the contactors 812 and 814 causing them to latch in. The contactors 812 and 814 are also electrically connected to an electrical system 808, often including a motor, of the heavy machinery or vehicle, providing power thereto via the battery 816. Additionally, when the PLC 810 receives the input signal from the push button 804, the PLC 810 is programmed to start a timer 824 which begins a predetermined countdown. The countdown can be preset, or changed, if desired. For example, the countdown can be set at 5 minutes, or less, or more. If after the countdown ends and the PLC 810 does not receive an input from an ignition switch 802, then the PLC 810 will time out and send power to the contactors 812 and 814 to unlatch them and again isolate the battery 816. When the contactors are latched in an active state indicator light 820 may illuminate. The indicator light 820 may be visible to the operator to ensure that the system 800 is active and functioning properly.

Additionally, the system 800 may include a first relay 823 and a second relay 825 that may be used to activate the contactors 812 and 814 which can then cut off the power to the PLC 810 to protect the PLC 810 from voltage spikes. These voltage spikes can cause temporary or permanent damage to the PLC and may occur or be caused by any known or unknown source. Similarly, relay 827 may be positioned between the ignition 802 and the PLC 810 and be configured to protect the PLC from transient voltage that can cause temporary or permanent damage to the PLC and may occur or be caused by any known or unknown source.

The system 800 may also include a WiFi interface 829 that may be configured to activate and test the system 800 from a remote location separated from the system 800, including the PLC 810. The WiFi interface 829 may also be configured to monitor ambient temperature, battery temperature and/or the temperature of any desired component or components of the system 800. The WiFi interface 829 is configured to monitor these temperatures via communication with a thermocouple interface 830. The thermocouple interface 830 may be configured to receive temperature data from a thermocouple 832, such that the temperature data may be transferred, transmitted or otherwise communicated between the thermocouple interface 830 and the WiFi interface 829, such that the WiFi interface 829 can transmit temperature data to a remote device, such as a computer, smart phone, tablet, laptop, or any other desired wifi capable device. The thermocouple 832 may be attached or engaged with the battery 816, or any other component of the system 800.

The system 800 may also include a secondary power supply 834 that may be used to provide power to the component of the system 800. The power supply 834 may be configured to supply constant power to the system 800, or may be configured as a backup power supply if the battery 816 fails to provide sufficient voltage or power to the system 800.

A test button 836 may also be added to the system 800to enable a user to test the system 800 or simulate a desired testing condition, such as a fire. The test button 836, for example, can send a signal triggering the system to shut off power from the battery 816, as if a fire or other hazardous condition existed. This test button 836 can therefore enable a user to test the system 800 prior to running the corresponding equipment to ensure proper operation.

As also illustrated in the circuit diagram in FIG. 10, when the contactors 812 and 814 are latched in and an input signal from the ignition switch 802 is received by the PLC 810, the battery 816 will maintain connection with the contactors 812 and 814 and provide power to the system 800 in an active state. When the system 800 is in the active state, the system 800 is monitored by at least one sensor 806, in at least one of three ways. The sensor 806 can monitor pressure, as with an Ansul system, or monitor heat, such as spot detecting with spot detector, or monitor flames, as with a fire eye sensor. The senor 806 in FIG. 10 is a pressure monitoring sensor, such as an Ansul system. If at any time the sensor 806 detects a hazard or problem, the sensor 806 sends a signal to the PLC 810. Additionally, is at any time the system 800 is not active or has detected a hazard, a second indicator light 818, such as a red light, may be illuminated indicating to the operator that the system is no longer active or receiving power from the battery 816.

Upon receiving a hazard signal from the sensor 806 the PLC 810 sends power, a voltage, to unlatch the contactors 812 and 814 to again isolate the battery and mitigate any damage done by the hazard. If no hazard is detected then the sensor will maintain the completed circuit through the timer 824 and start relay 828.

In situations where the heavy machinery or vehicle has been used without problem or hazard detection, at the end of operation when the operator is finished using the equipment, the ignition switch 802 is turned off, and the timer 824 will once again start its countdown. Once the countdown is completed without the ignition switch 802 being restarted, the PLC 810 will send power to unlatch the contactors 812 and 814 and isolate the battery 816, facilitating a longer battery life since the battery will be isolated from the machine while the machine is not in use.

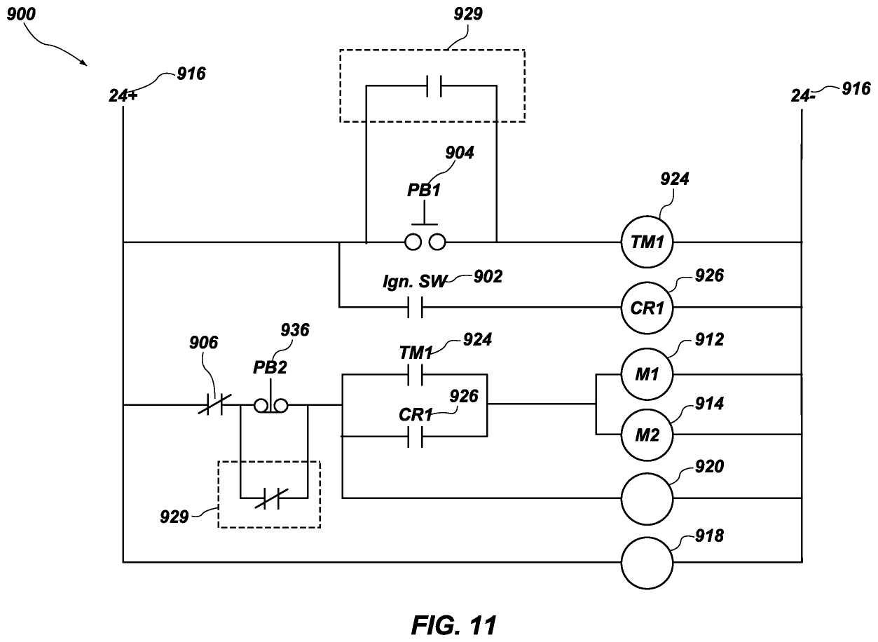

In another embodiment of the disclosed invention, as shown in FIG. 11, a battery interrupter system 900 includes an ignition switch 902 and a push button 904, or “on” button, which initiates the system 900. When an operator presses the push button 904 to initiate the system 900, the push button 904 sends an input signal to a programmable logic controller 910, or PLC, to begin starting or initiating the system 900.

When the operator first begins initiating the system 900, from a cold start, contactors 912 and 914 are in an open position, essentially isolating the battery 916, or batteries, from the rest of the system 900. By isolating the battery 916 in this way, the system 900 is not receiving any power, or open to receive power, from the battery 916, thereby conserving the battery power and limiting susceptibility to fire within the system 900. The battery 916 may be 24 volts, as shown in FIG. 11, or may be 12 volts or another desired voltage.

When the PLC 910 receives the input signal from the push button 904, the PLC 910 is programed to send power to the contactors 912 and 914 causing them to latch in. Additionally, when the PLC 910 receives the input signal from the push button 904, the PLC 910 is programmed to start a timer 224 which begins a predetermined countdown. The countdown can be preset, or changed, if desired. For example, the countdown can be set at 5 minutes, or less, or more. If after the countdown ends and the PLC 910 does not receive an input from an ignition switch 902, then the PLC 910 will time out and send power to the contactors 912 and 914 to unlatch them and again isolate the battery 916. When the contactors are latched in an active state indicator light 920 may illuminate. The indicator light 920 may be visible to the operator to ensure that the system 900 is active and functioning properly.

As also illustrated in the circuit diagram in FIG. 11, when the contactors 912 and 914 are latched in and an input signal from the ignition switch 902 is received by the PLC 910, the battery 916 will maintain connection with the contactors 912 and 914 and provide power to the system 900 in an active state. When the system 900 is in the active state, the system 900 is monitored by at least one sensor 906, in at least one of three ways. The sensor 206 can monitor pressure, as with an Ansul system, or monitor heat, such as spot detecting with spot detector, or monitor flames, as with a fire eye sensor. The senor 906 in FIG. 11 is a pressure monitoring sensor, such as an Ansul system. If at any time the sensor 906 detects a hazard or problem, the sensor 906 sends a signal to the PLC 910. Additionally, is at any time the system 900 is not active or has detected a hazard, a second indicator light 918, such as a red light, may be illuminated indicating to the operator that the system is no longer active or receiving power from the battery 916.

Upon receiving a hazard signal from the sensor 906 the PLC 910 sends power, a voltage, to unlatch the contactors 912 and 914 to again isolate the battery and mitigate any damage done by the hazard. If no hazard is detected then the sensor will maintain the completed circuit through the timer 924 and start relay 928.

In situations where the heavy machinery or vehicle has been used without problem or hazard detection, at the end of operation when the operator is finished using the equipment, the ignition switch 902 is turned off, and the timer 924 will once again start its countdown. Once the countdown is completed without the ignition switch 902 being restarted, the PLC 910 will send power to unlatch the contactors 912 and 914 and isolate the battery 916, facilitating a longer battery life since the battery will be isolated from the machine while the machine is not in use.

The system 900 may also include a WiFi interface 929 that may be configured to activate and test the system 900 from a remote location separated from the system 900, including the PLC 910. The WiFi interface 929 may also be configured to monitor ambient temperature, battery temperature and/or the temperature of any desired component or components of the system 900. The WiFi interface 929 is configured to monitor these temperatures via communication with a thermocouple interface 930. The thermocouple interface 930 may be configured to receive temperature data from a thermocouple 932, such that the temperature data may be transferred, transmitted or otherwise communicated between the thermocouple interface 930 and the WiFi interface 929, such that the WiFi interface 929 can transmit temperature data to a remote device, such as a computer, smart phone, tablet, laptop, or any other desired WiFi capable device. The thermocouple 932 may be attached or engaged with the battery 916, or any other component of the system 900.

A test button 936 may also be added to the system 900 to enable a user to test the system 900 or simulate a desired testing condition, such as a fire. The test button 936, for example, can send a signal triggering the system to shut off power from the battery 916, as if a fire or other hazardous condition existed. This test button 936 can therefore enable a user to test the system 900 prior to running the corresponding equipment to ensure proper operation.

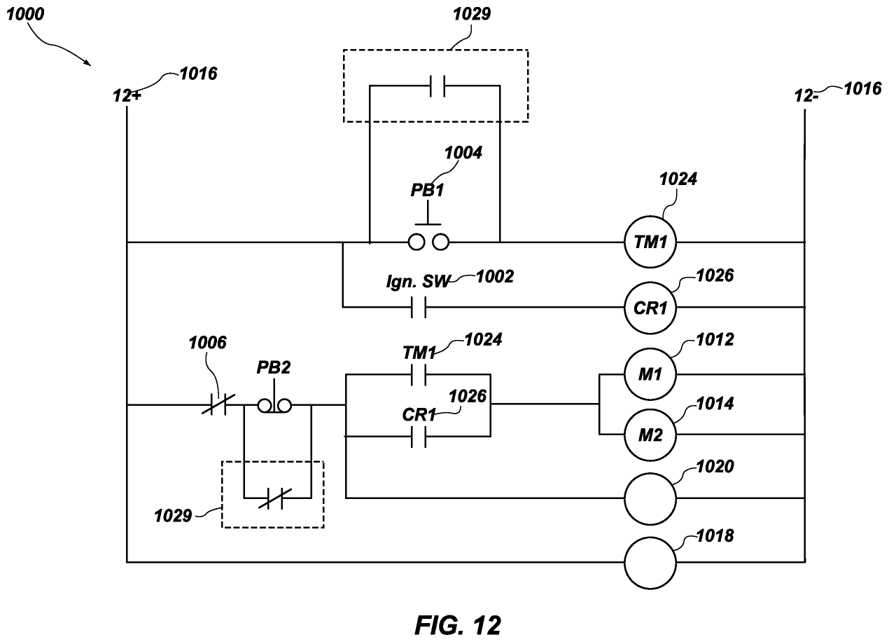

In another embodiment of the disclosed invention, as shown in FIG. 12, a battery interrupter system 1000 includes an ignition switch 1002 and a push button 1004, or “on” button, which initiates the system 1000. When an operator presses the push button 1004 to initiate the system 1000, the push button 1004 sends an input signal to a programmable logic controller 1010, or PLC, to begin starting or initiating the system 1000.

When the operator first begins initiating the system 300, from a cold start, contactors 1012 and 1014 are in an open position, essentially isolating the battery 1016, or batteries, from the rest of the system 1000. By isolating the battery 1016 in this way, the system 1000 is not receiving any power, or open to receive power, from the battery 1016, thereby conserving the battery power and limiting susceptibility to fire within the system 1000. The battery 1006 may be 12 volts, as shown in FIG. 12, or may be 24 volts or another desired voltage.

When the PLC 1010 receives the input signal from the push button 1004, the PLC 1010 is programed to send power to the contactors 1012 and 1014 causing them to latch in.

Additionally, when the PLC 1010 receives the input signal from the push button 1004, the PLC 1010 is programmed to start a timer 1024 which begins a predetermined countdown. The countdown can be preset, or changed, if desired. For example, the countdown can be set at 5 minutes, or less, or more. If after the countdown ends and the PLC 1010 does not receive an input from an ignition switch 1002, then the PLC 1010 will time out and send power to the contactors 1012 and 1014 to unlatch them and again isolate the battery 1016. When the contactors are latched in an active state indicator light 1020 may illuminate. The indicator light 1020 may be visible to the operator to ensure that the system 1000 is active and functioning properly.

As also illustrated in the circuit diagram in FIG. 12, when the contactors 1012 and 1014 are latched in and an input signal from the ignition switch 1002 is received by the PLC 1010, the battery 1016 will maintain connection with the contactors 1012 and 1014 and provide power to the system 1000 in an active state. When the system 1000 is in the active state, the system 1000 is monitored by at least one sensor 306, in at least one of three ways. The sensor 1006 can monitor pressure, as with an Ansul system, or monitor heat, with a spot detector, or monitor flames, as with a fire eye sensor. The senor 1006 in FIG. 12 is a heat monitoring sensor, such as an spot detector. If at any time the sensor 1006 detects a hazard or problem, the sensor 1006 sends a signal to the PLC 1010. Additionally, is at any time the system 1000 is not active or has detected a hazard, a second indicator light 1018, such as a red light, may be illuminated indicating to the operator that the system is no longer active or receiving power from the battery 1016.

Upon receiving a hazard signal from the sensor 1006 the PLC 1010 sends power, a voltage, to unlatch the contactors 1012 and 1014 to again isolate the battery and mitigate any damage done by the hazard. If no hazard is detected then the sensor will maintain the completed circuit through the timer 1024 and start relay 1028.

In situations where the heavy machinery or vehicle has been used without problem or hazard detection, at the end of operation when the operator is finished using the equipment, the ignition switch 1002 is turned off, and the timer 1024 will once again start its countdown. Once the countdown is completed without the ignition switch 1002 being restarted, the PLC 1010 will send power to unlatch the contactors 1012 and 1014 and isolate the battery 1016, facilitating a longer battery life since the battery will be isolated from the machine while the machine is not in use.

The system 1000 may also include a WiFi interface 1029 that may be configured to activate and test the system 1000 from a remote location separated from the system 1000, including the PLC 1010. The WiFi interface 1029 may also be configured to monitor ambient temperature, battery temperature and/or the temperature of any desired component or components of the system 1000. The WiFi interface 1029 is configured to monitor these temperatures via communication with a thermocouple interface 1030. The thermocouple interface 1030 may be configured to receive temperature data from a thermocouple 1032, such that the temperature data may be transferred, transmitted or otherwise communicated between the thermocouple interface 1030 and the WiFi interface 1029, such that the WiFi interface 1029 can transmit temperature data to a remote device, such as a computer, smart phone, tablet, laptop, or any other desired WiFi capable device. The thermocouple 1032 may be attached or engaged with the battery 1016, or any other component of the system 1000.

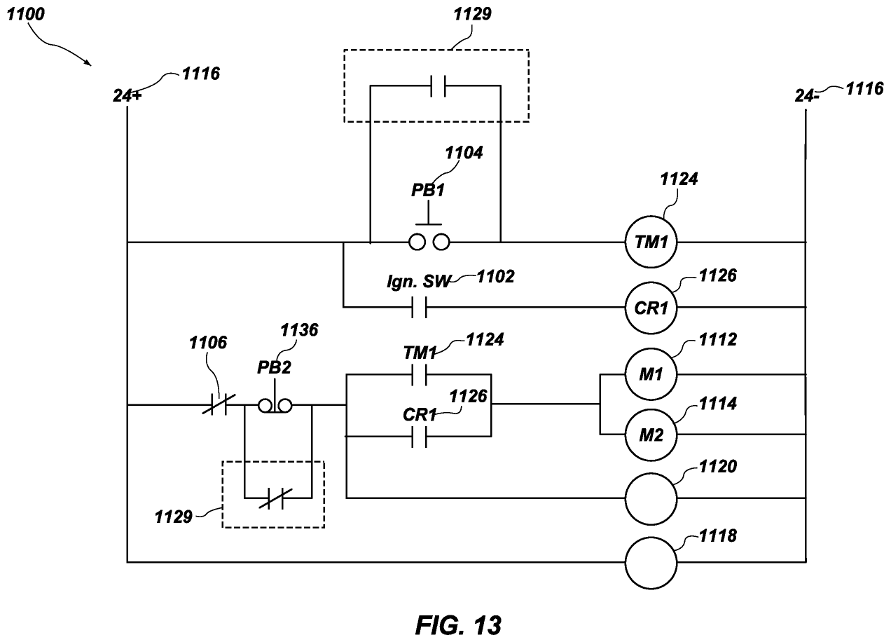

A test button 1036 may also be added to the system 1000 to enable a user to test the system 1000 or simulate a desired testing condition, such as a fire. The test button 1036, for example, can send a signal triggering the system to shut off power from the battery 1016, as if a fire or other hazardous condition existed. This test button 1036 can therefore enable a user to test the system 1000 prior to running the corresponding equipment to ensure proper operation. In another embodiment of the disclosed invention, as shown in FIG. 13, a battery interrupter system 1100 includes an ignition switch 1102 and a push button 1104, or “on” button, which initiates the system 1100. When an operator presses the push button 404 to initiate the system 1100, the push button 1104 sends an input signal to a programmable logic controller 1110, or PLC, to begin starting or initiating the system 1100.

When the operator first begins initiating the system 1100, from a cold start, contactors 1112 and 1114 are in an open position, essentially isolating the battery 1116, or batteries, from the rest of the system 1100. By isolating the battery 1116 in this way, the system 1100 is not receiving any power, or open to receive power, from the battery 1116, thereby conserving the battery power and limiting susceptibility to fire within the system 1100. The battery 1116 may be 24 volts, as shown in FIG. 13, or may be 14 volts or another desired voltage.

When the PLC 1110 receives the input signal from the push button 1104, the PLC 1110 is programed to send power to the contactors 1112 and 1114 causing them to latch in. Additionally, when the PLC 1110 receives the input signal from the push button 1104, the PLC 1110 is programmed to start a timer 1124 which begins a predetermined countdown. The countdown can be preset, or changed, if desired. For example, the countdown can be set at 5 minutes, or less, or more. If after the countdown ends and the PLC 1110 does not receive an input from an ignition switch 1102, then the PLC 1110 will time out and send power to the contactors 1112 and 1114 to unlatch them and again isolate the battery 1116. When the contactors are latched in an active state indicator light 1120 may illuminate. The indicator light 1120 may be visible to the operator to ensure that the system 1100 is active and functioning properly.

As also illustrated in the circuit diagram in FIG. 13, when the contactors 1112 and 1114 are latched in and an input signal from the ignition switch 1102 is received by the PLC 1110, the battery 1116 will maintain connection with the contactors 1112 and 1114 and provide power to the system 1100 in an active state. When the system 1100 is in the active state, the system 1100 is monitored by at least one sensor 1106, in at least one of three ways. The sensor 1106 can monitor pressure, as with an Ansul system, or monitor heat, with a spot detector, or monitor flames, as with a fire eye sensor. The senor 1106 in FIG. 13 is a heat monitoring sensor, such as an spot detector. If at any time the sensor 1106 detects a hazard or problem, the sensor 1106 sends a signal to the PLC 1110. Additionally, is at any time the system 1100 is not active or has detected a hazard, a second indicator light 1118, such as a red light, may be illuminated indicating to the operator that the system is no longer active or receiving power from the battery 1116.

Upon receiving a hazard signal from the sensor 1106 the PLC 1110 sends power, a voltage, to unlatch the contactors 1112 and 1114 to again isolate the battery and mitigate any damage done by the hazard. If no hazard is detected then the sensor will maintain the completed circuit through the timer 1124 and start relay 1128.

In situations where the heavy machinery or vehicle has been used without problem or hazard detection, at the end of operation when the operator is finished using the equipment, the ignition switch 1102 is turned off, and the timer 1124 will once again start its countdown. Once the countdown is completed without the ignition switch 1102 being restarted, the PLC 1110 will send power to unlatch the contactors 1112 and 1114 and isolate the battery 1116, facilitating a longer battery life since the battery will be isolated from the machine while the machine is not in use.

The system 1100 may also include a WiFi interface 1129 that may be configured to activate and test the system 1100 from a remote location separated from the system 1100, including the PLC 1110. The WiFi interface 1129 may also be configured to monitor ambient temperature, battery temperature and/or the temperature of any desired component or components of the system 1100. The WiFi interface 1129 is configured to monitor these temperatures via communication with a thermocouple interface 1130. The thermocouple interface 1130 may be configured to receive temperature data from a thermocouple 1132, such that the temperature data may be transferred, transmitted or otherwise communicated between the thermocouple interface 1130 and the WiFi interface 1129, such that the WiFi interface 1129 can transmit temperature data to a remote device, such as a computer, smart phone, tablet, laptop, or any other desired WiFi capable device. The thermocouple 1132 may be attached or engaged with the battery 1116, or any other component of the system 1100.

A test button 1136 may also be added to the system 1100 to enable a user to test the system 1100 or simulate a desired testing condition, such as a fire. The test button 1136, for example, can send a signal triggering the system to shut off power from the battery 1116, as if a fire or other hazardous condition existed. This test button 1136 can therefore enable a user to test the system 1100 prior to running the corresponding equipment to ensure proper operation.

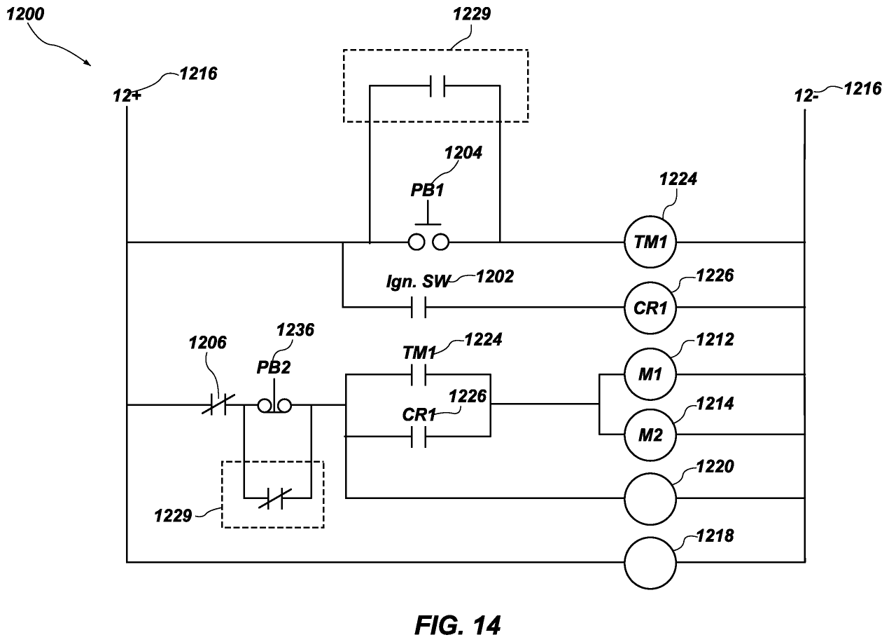

In another embodiment of the disclosed invention, as shown in FIG. 14, a battery interrupter system 1200 includes an ignition switch 1202 and a push button 1204, or “on” button, which initiates the system 1200. When an operator presses the push button 1204 to initiate the system 1200, the push button 1204 sends an input signal to a programmable logic controller 1210, or PLC, to begin starting or initiating the system 1200.

When the operator first begins initiating the system 1200, from a cold start, contactors 1212 and 1214 are in an open position, essentially isolating the battery 1216, or batteries, from the rest of the system 1200. By isolating the battery 1216 in this way, the system 1200 is not receiving any power, or open to receive power, from the battery 1216, thereby conserving the battery power and limiting susceptibility to fire within the system 1200. The battery 1216 may be 12 volts, as shown in FIG. 14, or may be 24 volts or another desired voltage.

When the PLC 1210 receives the input signal from the push button 1204, the PLC 1210 is programed to send power to the contactors 1212 and 1214 causing them to latch in. Additionally, when the PLC 1210 receives the input signal from the push button 1204, the PLC 1210 is programmed to start a timer 1224 which begins a predetermined countdown. The countdown can be preset, or changed, if desired. For example, the countdown can be set at 5 minutes, or less, or more. If after the countdown ends and the PLC 1210 does not receive an input from an ignition switch 1202, then the PLC 1210 will time out and send power to the contactors 1212 and 1214 to unlatch them and again isolate the battery 1216. When the contactors are latched in an active state indicator light 1220 may illuminate. The indicator light 1220 may be visible to the operator to ensure that the system 1200 is active and functioning properly.

As also illustrated in the circuit diagram in FIG.14, when the contactors 1212 and 1214 are latched in and an input signal from the ignition switch 1202 is received by the PLC 1210, the battery 1216 will maintain connection with the contactors 1212 and 1214 and provide power to the system 1200 in an active state. When the system 1200 is in the active state, the system 1200 is monitored by at least one sensor 1206, in at least one of three ways. The sensor 1206 can monitor pressure, as with an Ansul system, or monitor heat, with a spot detector, or monitor flames, as with a fire eye sensor. The senor 1206 in FIG. 14 is a flame monitoring sensor, such as a fire eye sensor. If at any time the sensor 1206 detects a hazard or problem, the sensor 1206 sends a signal to the PLC 1210. Additionally, is at any time the system 1200 is not active or has detected a hazard, a second indicator light 1218, such as a red light, may be illuminated indicating to the operator that the system is no longer active or receiving power from the battery 1216.

Upon receiving a hazard signal from the sensor 1206 the PLC 1210 sends power, a voltage, to unlatch the contactors 1212 and 1214 to again isolate the battery and mitigate any damage done by the hazard. If no hazard is detected then the sensor will maintain the completed circuit through the timer 1224 and start relay 1228.

In situations where the heavy machinery or vehicle has been used without problem or hazard detection, at the end of operation when the operator is finished using the equipment, the ignition switch 1202 is turned off, and the timer 1224 will once again start its countdown. Once the countdown is completed without the ignition switch 1202 being restarted, the PLC 1210 will send power to unlatch the contactors 1212 and 1214 and isolate the battery 1216, facilitating a longer battery life since the battery will be isolated from the machine while the machine is not in use.

The system 1200 may also include a WiFi interface 1229 that may be configured to activate and test the system 1200 from a remote location separated from the system 1200, including the PLC 1210. The WiFi interface 1229 may also be configured to monitor ambient temperature, battery temperature and/or the temperature of any desired component or components of the system 1200. The WiFi interface 1229 is configured to monitor these temperatures via communication with a thermocouple interface 1230. The thermocouple interface 1230 may be configured to receive temperature data from a thermocouple 1232, such that the temperature data may be transferred, transmitted or otherwise communicated between the thermocouple interface 1230 and the WiFi interface 1229, such that the WiFi interface 1229 can transmit temperature data to a remote device, such as a computer, smart phone, tablet, laptop, or any other desired WiFi capable device. The thermocouple 1232 may be attached or engaged with the battery 1216, or any other component of the system 1200.

A test button 1236 may also be added to the system 1200 to enable a user to test the system 1200 or simulate a desired testing condition, such as a fire. The test button 1236, for example, can send a signal triggering the system to shut off power from the battery 1216, as if a fire or other hazardous condition existed. This test button 1236 can therefore enable a user to test the system 1200 prior to running the corresponding equipment to ensure proper operation.

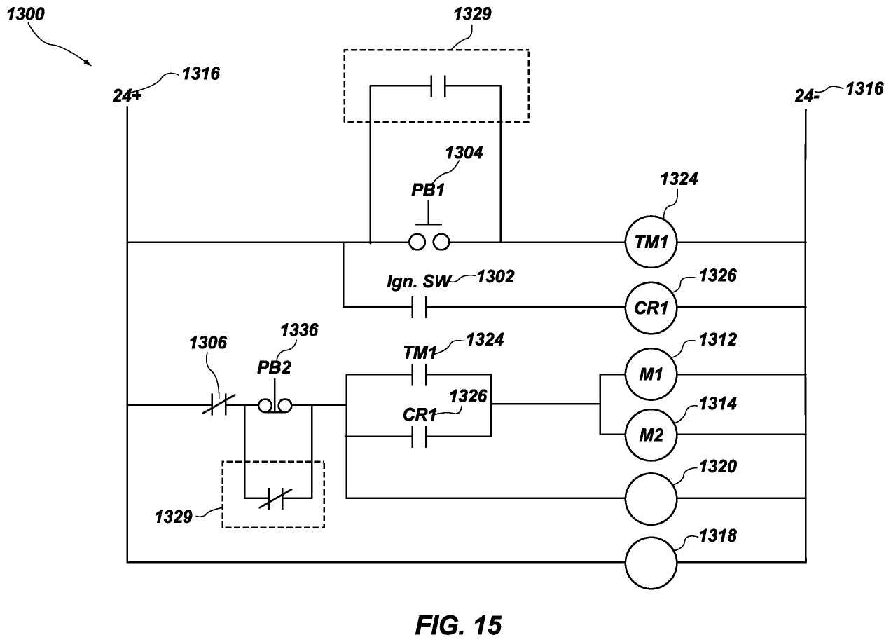

In another embodiment of the disclosed invention, as shown in FIG. 15, a battery interrupter system 1300 includes an ignition switch 1302 and a push button 1304, or “on” button, which initiates the system 1300. When an operator presses the push button 1304 to initiate the system 1300, the push button 1304 sends an input signal to a programmable logic controller 1310, or PLC, to begin starting or initiating the system 1300.

When the operator first begins initiating the system 600, from a cold start, contactors 1312 and 1314 are in an open position, essentially isolating the battery 1316, or batteries, from the rest of the system 1300. By isolating the battery 1316 in this way, the system 1300 is not receiving any power, or open to receive power, from the battery 1316, thereby conserving the battery power and limiting susceptibility to fire within the system 1300. The battery 1316 may be 24 volts, as shown in FIG. 15, or may be 12 volts or another desired voltage.

When the PLC 1310 receives the input signal from the push button 1304, the PLC 1310 is programed to send power to the contactors 1312 and 1314 causing them to latch in. Additionally, when the PLC 1310 receives the input signal from the push button 1304, the PLC 1310 is programmed to start a timer 1324 which begins a predetermined countdown. The countdown can be preset, or changed, if desired. For example, the countdown can be set at 6 minutes, or less, or more. If after the countdown ends and the PLC 1310 does not receive an input from an ignition switch 1302, then the PLC 1310 will time out and send power to the contactors 1312 and 1314 to unlatch them and again isolate the battery 1316. When the contactors are latched in an active state indicator light 1320 may illuminate. The indicator light 1320 may be visible to the operator to ensure that the system 1300 is active and functioning properly.

As also illustrated in the circuit diagram in FIG.15, when the contactors 1312 and 1314 are latched in and an input signal from the ignition switch 1302 is received by the PLC 1310, the battery 1316 will maintain connection with the contactors 1312 and 1314 and provide power to the system 1300 in an active state. When the system 1300 is in the active state, the system 1300 is monitored by at least one sensor 1306, in at least one of three ways. The sensor 1306 can monitor pressure, as with an Ansul system, or monitor heat, with a spot detector, or monitor flames, as with a fire eye sensor. The senor 1306 in FIG. 15 is a flame monitoring sensor, such as a fire eye sensor. If at any time the sensor 1306 detects a hazard or problem, the sensor 1306 sends a signal to the PLC 1310. Additionally, is at any time the system 1300 is not active or has detected a hazard, a second indicator light 1318, such as a red light, may be illuminated indicating to the operator that the system is no longer active or receiving power from the battery 1316.

Upon receiving a hazard signal from the sensor 1306 the PLC 1310 sends power, a voltage, to unlatch the contactors 1312 and 1314 to again isolate the battery and mitigate any damage done by the hazard. If no hazard is detected then the sensor will maintain the completed circuit through the timer 1324 and start relay 1328.

In situations where the heavy machinery or vehicle has been used without problem or hazard detection, at the end of operation when the operator is finished using the equipment, the ignition switch 1302 is turned off, and the timer 1324 will once again start its countdown. Once the countdown is completed without the ignition switch 1302 being restarted, the PLC 1310 will send power to unlatch the contactors 1312 and 1314 and isolate the battery 1316, facilitating a longer battery life since the battery will be isolated from the machine while the machine is not in use.

The system 1300 may also include a WiFi interface 1329 that may be configured to activate and test the system 1300 from a remote location separated from the system 1300, including the PLC 1310. The WiFi interface 1329 may also be configured to monitor ambient temperature, battery temperature and/or the temperature of any desired component or components of the system 1300. The WiFi interface 1329 is configured to monitor these temperatures via communication with a thermocouple interface 1330. The thermocouple interface 1330 may be configured to receive temperature data from a thermocouple 1332, such that the temperature data may be transferred, transmitted or otherwise communicated between the thermocouple interface 1330 and the WiFi interface 1329, such that the WiFi interface 1329 can transmit temperature data to a remote device, such as a computer, smart phone, tablet, laptop, or any other desired WiFi capable device. The thermocouple 1332 may be attached or engaged with the battery 1316, or any other component of the system 1300.

A test button 1336 may also be added to the system 1300 to enable a user to test the system 1300 or simulate a desired testing condition, such as a fire. The test button 1336, for example, can send a signal triggering the system to shut off power from the battery 1316, as if a fire or other hazardous condition existed. This test button 1336 can therefore enable a user to test the system 1300 prior to running the corresponding equipment to ensure proper operation.

It will be appreciated that the structure and apparatus disclosed herein is merely one example of a means for providing a battery interrupter, and it should be appreciated that any structure, apparatus or system for a battery interrupter which performs functions the same as, or equivalent to, those disclosed herein are intended to fall within the scope of a means for providing a battery interrupter, including those structures, apparatus or systems for providing a battery interrupter which are presently known, or which may become available in the future. Anything which functions the same as, or equivalently to, a means for providing a battery interrupter falls within the scope of this element.

Those having ordinary skill in the relevant art will appreciate the advantages provide by the features of the present disclosure.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A battery interrupter system comprising:
a electrical motor for a machine;
at least one battery which powers an electrical system of a machine;
a programable logic controller electrically connected to the electrical system;
an ignition electrically connected to the programmable logic controller;
a button, which initiates the battery interrupter system, is connected to the programmable logic controller;
at least one contactor electrically connected to the at least one battery and the programmable logic controller, wherein the programmable logic controller is configured to sends a signal to the at least one contactor to latch-in the contactor and enable an electrical connection between the at least one battery and the electrical system of the machine;
a detection sensor electrically connected to the programmable logic controller, wherein the detection sensor identifies operating conditions of the electrical system; and
a wifi interface configured to communicate an operating condition of the electrical system to a remote device.

2. The battery interrupter system of claim 1, wherein the detection sensor identifies heat conditions.

3. The battery interrupter system of claim 1, wherein the detection sensor identifies pressure conditions.

4. The battery interrupter system of claim 1, wherein the detection sensor identifies fire conditions.

5. The battery interrupter system of claim 1, wherein the programmable logic controller includes a timer configured to measure the time between the initiation of the button and the initiation of the ignition, and wherein if a predetermined amount of time lapses between when the initiation of the button and the initiation of the ignition occurs, the programmable logic controller will send a signal to the at least one contactor to unlatch the contactor and disrupt the electrical connection between the battery and the electrical system.

6. The battery interrupter system of claim 1, wherein the detection sensor is configured to send a signal to the programmable logic controller when a predetermined condition is detected, and when the predetermined connection is detected the programmable logic controller will send a signal to the at least one contactor to unlatch the contactor and disrupt the electrical connection between the battery and the electrical system.

7. The battery interrupter system of claim 6, wherein the predetermined condition is a heat condition.

8. The battery interrupter system of claim 6, wherein the predetermined condition is a pressure condition.

9. The battery interrupter system of claim 6, wherein the predetermined condition is a fire condition.

10. A battery interrupter system comprising:
a machine having an electrical system;
at least one battery which powers the electrical system of the machine;
a programable logic controller electrically connected to the electrical system;
an ignition electrically connected to the programmable logic controller;
a button, which initiates the battery interrupter system, is connected to the programmable logic controller;
at least one contactor electrically connected to the at least one battery and the programmable logic controller, wherein the programmable logic controller is configured to sends a signal to the at least one contactor to latch-in the contactor and enable an electrical connection between the at least one battery and the electrical system of the machine;
wherein the programmable logic controller includes a timer configured to measure the time between the initiation of the button and the initiation of the ignition, and wherein if a predetermined amount of time lapses between when the initiation of the button and the initiation of the ignition occurs, the programmable logic controller will send a signal to the at least one contactor to unlatch the contactor and disrupt the electrical connection between the battery and the electrical system; and
a wifi interface configured to communicate an operating condition of the electrical system to a remote device, wherein the operating condition is detected by a thermocouple.

11. The battery interrupter system of claim 10, further comprises:
a detection sensor electrically connected to the programmable logic controller, wherein the detection sensor identifies operating conditions of the electrical system.

12. The battery interrupter system of claim 11, wherein the detection sensor identifies heat conditions.

13. The battery interrupter system of claim 11, wherein the detection sensor identifies pressure conditions.

14. The battery interrupter system of claim 11, wherein the detection sensor identifies fire conditions.

15. The battery interrupter system of claim 11, wherein the detection sensor is configured to send a signal to the programmable logic controller when a predetermined condition is detected, and when the predetermined connection is detected the programmable logic controller will send a signal to the at least one contactor to unlatch the contactor and disrupt the electrical connection between the battery and the electrical system.

16. The battery interrupter system of claim 15, wherein the predetermined condition is a heat condition.

17. The battery interrupter system of claim 15, wherein the predetermined condition is a pressure condition.

18. The battery interrupter system of claim 15, wherein the predetermined condition is a fire condition.
